(19) United States
(12) Patent Application Publication
(10) Pub. No.: US 2024/0220579 A1
(43) Pub. Date: Jul. 4, 2024

(54) SYSTEM AND METHOD FOR TRAINING A MACHINE LEARNING NETWORK

(71) Applicant: Actimize LTD., Ra'anana (IL)

(72) Inventors: Prasad MHATRE, Pune (IN); Sumit KUMAR, Pune (IN)

(21) Appl. No.: 18/149,451

(22) Filed: Jan. 3, 2023

(51) Int. Cl. G06F 18/214; G06F 18/211

(52) U.S. Cl. CPC G06F 18/2155; G06F 18/211

(57) ABSTRACT

A system adapted to automatically label data records includes a processor with instructions to: receive a set of data records, each record including features that have been matched against a list of data records having a particular characteristic. Some data records are labeled as having the particular characteristic, some are labeled as not having the particular characteristic, and a large majority are unlabeled. A machine learning model is trained on the labeled data records, and then used to assign probability scores to each unlabeled record. Repeatedly, the system selects an unlabeled data record that matches a decision criterion and, with a label propagation algorithm, labels the selected data record as either having the particular characteristic or not having the particular characteristic. The trained machine learning model is then updated to include the selected record as a labeled record. This process repeats until all of the unlabeled records have been labeled.

### COPYRIGHT NOTICE

A portion of the disclosure of this patent document contains material which is subject to copyright protection. The copyright owner has no objection to the facsimile reproduction by anyone of the patent document or the patent disclosure, as it appears in the U.S. Patent and Trademark Office patent file or records, but otherwise reserves all copyright rights whatsoever.

### TECHNICAL FIELD

The subject matter described herein relates to systems, methods, and devices for training a machine learning network using an incompletely labeled dataset. This active machine learning labeling system has particular but not exclusive utility in contact centers and other customer-facing support centers.

### BACKGROUND

Machine learning (ML) is used for many purposes. Accurate prediction is the goal of any good machine learning model, which in turn, helps users make good decisions. The challenge across industries is to be efficient and improve customer experience, which may be difficult with poorly trained ML models, as incorrectly trained models can create false alarms, bias, and other problems that affect decisioning elsewhere in the system. For example, erroneous predictions can lead to ineffective campaigning, inefficient management decisions, incorrect medical diagnoses, etc. In the context of fraud management within the finance industry, ML may be used for watch list filtering, e.g., to check whether the originator of a given transaction is on a fraud watch list.

Labeled data is an integral feature of the training process for ML models. Labels may for example be added to data by a human subject matter expert, indicating the content of an image, the diagnosis of a patient, or whether a particular transaction is fraudulent. Across multiple industries, a common ML problem is the existence of abundant data for which such human-added labels are sparse or nonexistent. For supervised learning, a large body of labeled data may be needed. However, labeling is time-consuming, labor-intensive, and generally requires the attention of subject matter experts, leading to high costs. Labeling may for example require a dedicated in-house workforce, or outsourcing to a specialty firm. For example, determining whether a transaction originates from a watch-list-flagged entity can be a slow, labor-intensive, error-prone process.

In addition, poor data quality may hamper effective labeling, and mistakes in the labeling process can lead to poorly trained models. In some cases, training data may include private information, raising concerns about storage, handling, exposure, and retention or deletion of the data. According to a survey conducted in May 2020 by Statista, more than 50% of companies who use (or desire to use) ML models lack labels for their available data set. Existing solutions as of this writing do not have a mechanism for dealing with low-labeled data (e.g., data for which labels exist on only a small minority of records), and may thus suffer from a high rate of false positives or false negatives when implementing the ML. For example, in today's anti-money laundering (AML), investment fund manager (IFM) domain, there are few known fraudulent transactions, and building a machine learning model on this data results in lot of false positive fraud predictions, which can cause heavy loss to businesses due to poor or incorrect decisions in the system. Hence, a need exists for training ML models without large bodies of labeled data.

### SUMMARY

A need exists for systems, methods, and devices that can train an ML model with low-labeled data with increased accuracy, which can then enable businesses to make better decisions. The present disclosure provides an active machine learning labeling system that can learn from sparsely labeled data, and that can generate labels for a large body of unlabeled records. In order to minimize the computational burden, some embodiments identify key records from pools of unlabeled data that are easiest to label with high confidence, and prioritize the labeling of these key records. Once labeled, the data can be used for classification, regression, ranking models, etc.

The active machine learning labeling system begins with a pool of labeled and unlabeled data. From the available labeled data, a training module builds an initial ML model. An “active learner” module then queries a record from the unlabeled pool. The active learner module will send the record to an oracle module, which uses the trained ML model along with statistical methods to label the selected record (e.g. as a fraudulent or non-fraudulent transaction) and add it to the pool of labeled records. The training module then updates the training of the ML network to include the labeled record in the training dataset. This process is then repeated until all (or substantially all) of the unlabeled data has been labeled, thus reducing the need for a human-in-loop while training the machine learning model.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions. One general aspect includes a system adapted to automatically label data records. The system includes a processor and a non-transitory computer readable medium operably coupled thereto. The computer readable medium may include a plurality of instructions stored in association therewith that are accessible to, and executable by, the processor, to perform operations which may include: receiving a set of data records, where each data record of the set of data records may include a set of features that have been matched against a list of data records having a particular characteristic, where some data records of the set of data records are labeled as having the particular characteristic, where some data records of the set of data records are labeled as not having the particular characteristic, where a majority of the data records of the set of data records are not labeled. The instructions also include: with the data records labeled as having the particular characteristic and the data records labeled as not having the particular characteristic, training a machine learning model; with the trained machine learning model, of the set of data records that are not labeled, classifying each data record as either having the particular characteristic or not having the particular characteristic; for at least some data records of the data records that are not labeled: selecting a data record of the at least some data records that matches a decision criterion; with a label propagation algorithm, labeling the selected data record as either having the particular characteristic or not having the particular characteristic; and updating the trained machine learning model to include the selected data record and the labeling of the selected data record. Other embodiments of this aspect include corresponding computer systems, apparatus, and computer programs recorded on one or more computer storage devices, each configured to perform the actions of the methods.

Implementations may include one or more of the following features. In some embodiments, the at least some data records may include all of the data records that are not labeled. In some embodiments, the at least some data records may include, of the data records that are not labeled, a subset of data records selected by the label propagation algorithm. In some embodiments, the label propagation algorithm employs least confidence sampling, margin sampling, or entropy-based sampling, or a combination thereof. In some embodiments, the data records of the set of data records are mapped into a multidimensional space where each axis of the space represents a feature of the set of features. In some embodiments, a decision boundary in the multidimensional space divides data records of the set of data records having the particular characteristic from data records of the set of data records not having the particular characteristic. In some embodiments, the decision criterion may include determining on which side of the decision boundary the selected data record falls. In some embodiments, each axis of the space represents a feature of the set of features, labeled neighbors from the data records labeled as having the particular characteristic and the data records labeled as not having the particular characteristic. In some embodiments, the decision criterion may include determining whether a majority of the labeled neighbors within a given search radius are labeled as having the particular characteristic. In some embodiments, the decision criterion may include determining whether a weighted majority of the labeled neighbors are labeled as having the particular characteristic, where the weighting is based on a distance between the selected record and each respective labeled neighbor within the multidimensional space. In some embodiments, the particular characteristic may include a suspicion that the data record is fraudulent, and the list of data records having the particular characteristic may include a list of known fraud sources. Implementations of the described techniques may include hardware, a method or process, or computer software on a computer-accessible medium.

One general aspect includes a computer-implemented method adapted to automatically label data records. The computer-implemented method includes receiving a set of data records, where each data record of the set of data records may include a set of features that have been matched against a list of data records having a particular characteristic, where some data records of the set of data records are labeled as having the particular characteristic, where some data records of the set of data records are labeled as not having the particular characteristic, where a majority of the data records of the set of data records are not labeled. The method also includes, with the data records labeled as having the particular characteristic and the data records labeled as not having the particular characteristic, training a machine learning model and, with the trained machine learning model, of the set of data records that are not labeled, classifying each data record as either having the particular characteristic or not having the particular characteristic. The method also includes, for at least some data records of the data records that are not labeled: selecting a data record of the at least some data records that matches a decision criterion; with a label propagation algorithm, labeling the selected data record as either having the particular characteristic or not having the particular characteristic; and updating the trained machine learning model to include the selected data record and the labeling of the selected data record. Other embodiments of this aspect include corresponding computer systems, apparatus, and computer programs recorded on one or more computer storage devices, each configured to perform the actions of the methods.

Implementations may include one or more of the following features. In some embodiments, the at least some data records may include all of the data records that are not labeled. In some embodiments, the at least some data records may include, of the data records that are not labeled, a subset of data records selected by the label propagation algorithm. In some embodiments, the label propagation algorithm employs least confidence sampling, margin sampling, or entropy-based sampling, or a combination thereof. In some embodiments, the data records of the set of data records are mapped into a multidimensional space where each axis of the space represents a feature of the set of features, where a decision boundary in the multidimensional space divides data records of the set of data records having the particular characteristic from data records of the set of data records not having the particular characteristic, and where the decision criterion may include determining on which side of the decision boundary the selected data record falls. In some embodiments, each axis of the space represents a feature of the set of features, labeled neighbors from the data records labeled as having the particular characteristic and the data records labeled as not having the particular characteristic. In some embodiments, the decision criterion may include determining whether a majority of the labeled neighbors within a given search radius are labeled as having the particular characteristic. In some embodiments, the decision criterion may include determining whether a weighted majority of the labeled neighbors are labeled as having the particular characteristic, where the weighting is based on a distance between the selected record and each respective labeled neighbor within the multidimensional space. In some embodiments, the decision criterion may include determining whether a majority of the labeled neighbors within a given search radius are labeled as having the particular characteristic. In some embodiments, the decision criterion may include determining whether a weighted majority of the labeled neighbors are labeled as having the particular characteristic, where the weighting is based on a distance between the selected record and each respective labeled neighbor within the multidimensional space. In some embodiments, the decision criterion may include determining whether a majority of the labeled neighbors within a given search radius are labeled as having the particular characteristic. In some embodiments, the decision criterion may include determining whether a weighted majority of the labeled neighbors are labeled as having the particular characteristic, where the weighting is based on a distance between the selected record and each respective labeled neighbor within the multidimensional space. The particular characteristic may include a suspicion that the data record is fraudulent, and the list of data records having the particular characteristic may include a list of known fraud sources. Implementations of the described techniques may include hardware, a method or process, or computer software on a computer-accessible medium.

This Summary is provided to introduce a selection of concepts in a simplified form that are further described below in the Detailed Description. This Summary is not intended solely to identify key features or essential features of the claimed subject matter, nor is it intended to limit the scope of the claimed subject matter. A more extensive presentation of features, details, utilities, and advantages of the active machine learning labeling system, as defined in the claims, is provided in the following written description of various embodiments of the disclosure and illustrated in the accompanying drawings.

### BRIEF DESCRIPTION OF THE DRAWINGS

Illustrative embodiments of the present disclosure will be described with reference to the accompanying drawings, of which:

FIG. 1 is a representation, in block diagram form, of at least a portion of an example present-day, prior art training process for a machine learning model, according to aspects of the present disclosure

FIG. 2 is a representation, in block diagram form, of at least a portion of an active machine learning labeling system, according to aspects of the present disclosure.

FIG. 3 is a representation, in block diagram form, of at least a portion of an active machine learning labeling system, according to aspects of the present disclosure

FIG. 4 is a representation, in block diagram form, of at least a portion of a watch list filtering system, according to aspects of the present disclosure.

FIG. 5 is a representation, in block diagram form, of at least a portion of an example data generation module of an active machine learning labeling system, according to aspects of the present disclosure.

FIG. 6 is a representation, in block diagram form, of at least a portion of an active machine learning labeling system, according to aspects of the present disclosure.

FIG. 7 is a comparison of four scatterplots showing the performance of the active machine learning labeling system, according to aspects of the present disclosure.

FIG. 8 is a representation, in a hybrid block/flow diagram form, of at least a portion of an active machine learning labeling system, according to aspects of the present disclosure.

FIG. 9 is a representation, in a hybrid block/flow diagram form, of at least a portion of an active machine learning labeling system, according to aspects of the present disclosure.

FIG. 10 is a representation, in flow diagram form, of at least a portion of an example active machine learning labeling method, according to aspects of the present disclosure.

FIG. 11 is a graph showing classification accuracy over time for an ML model of the active machine learning labeling system, according to aspects of the present disclosure.

FIG. 12 is a graph showing classification accuracy over time for an ML model of the active machine learning labeling system using a pool-based sampling strategy, according to aspects of the present disclosure.

FIG. 13 is a graph showing classification accuracy over time for an ML model of the active machine learning labeling system using a ranked batch-mode sampling strategy, according to aspects of the present disclosure.

FIG. 14 is a graph showing classification accuracy over time for an ML model of the active machine learning labeling system using a query-by-committee sampling strategy, according to aspects of the present disclosure.

FIG. 15 is a comparison table showing the accuracies of different querying strategies for an example active machine learning labeling system, according to aspects of the present disclosure.

FIG. 16 is an example user interface screen for an active machine learning labeling system, according to aspects of the present disclosure.

FIG. 17 is an example user interface screen for an active machine learning labeling system, according to aspects of the present disclosure.

FIG. 18 is an example user interface screen for an active machine learning labeling system, according to aspects of the present disclosure.

FIG. 19 is an example user interface screen for an active machine learning labeling system, according to aspects of the present disclosure.

FIG. 20 is an example user interface screen for an active machine learning labeling system, according to aspects of the present disclosure.

FIG. 21 is an example user interface screen for an active machine learning labeling system, according to aspects of the present disclosure.

FIG. 22 is a schematic diagram of a processor circuit, according to aspects of the present disclosure.

### DETAILED DESCRIPTION

A need exists for systems, methods, and devices that can train an ML model with low-labeled data with increased accuracy, which can then enable businesses to make better decisions. The present disclosure provides such systems, methods, and devices, which can learn from hidden insights available in the sparse, labeled data, and generate labels for a large body of unlabeled records. In order to minimize the computational burden, some embodiments identify key records from pools of unlabeled data that are easiest to label with high confidence, and prioritize the labeling of these key records. Once labeled, the data can be used for classification, regression, ranking models, etc.

The active machine learning labeling system begins with a pool of labeled and unlabeled data. From the available labeled data, a training module builds an initial ML model. An “active learner” module then queries a record from the unlabeled pool. The active learner queries the unlabeled data by using various strategies such as least confidence sampling, margin sampling, entropy sampling, etc., to select the next record to be labeled (e.g., the record that will be easiest to label accurately, relative to other unlabeled records). Based upon different strategies, the active learner module will send the record to an oracle module, which uses the trained ML model along with statistical methods to label the selected record (e.g., as a fraudulent or non-fraudulent transaction) and add it to the pool of labeled records. The training module then updates the training of the ML network to include the labeled record in the training dataset. This process is then repeated until all, or substantially all, of the unlabeled data has been labeled. It is possible that some minor portion of the records remain unlabeled by the training module, for example, if a pre-selected margin of confidence for any potential labeling is too low to be considered reliable.

To reduce the computational burden for large datasets, in some embodiments the active learner module may select more than one record to be sent to the oracle module and training module at a time (e.g., 10 records at a time, 20 records at a time, etc.). In other embodiments, the system does not use an active learner module to select the next record, but merely labels the records one-by-one or in groups, without selection criteria. However, this approach may be more computationally intensive and less accurate.

All of the described embodiments of the active machine learning labeling system reduce the need for labeled data, and eliminate the need for a human-in-loop while training the machine learning model.

Using this approach, a machine learning model is constructed which has increased accuracy than previous supervised learning models used on low-labeled data. In some embodiments, a certain percentage of labeled records are held back from the training process and are used instead for validation. The correctness of the model's predictions can be validated by comparing against the actual labels for those validation records. The active machine learning labeling system can be used in various domains where low-labeled data is available, and can be used to build ML models that are more accurate than models trained using only the labeled data, and thus efficiently provide superior predictions.

The active machine learning labeling system can be used in applications such as investment fund management (IFM), WLX, and anti-money-laundering (AML) products, and can have a substantial impact on various domain operations including increased accuracy (e.g., leading to reduced business losses in AML).

The active machine learning labeling system operates generally in three phases. In Phase 1, the model is trained using whatever labeled data is available. Where such labeled data represents only a small minority of the available records, the resulting ML model's prediction accuracy may be relatively inaccurate, but can nevertheless help observe patterns in the data and thus generate insights from the available labels. This can improve the accuracy of future labeling. The system then runs the ML model on unlabeled records, considering them as test data, with a prediction probability assigned to each unlabeled record. Novel algorithms then query one or more records from the unlabeled pool for labeling based on priority, as determined for example by least confidence sampling, margin sampling, entropy sampling, etc., to select records that have the highest probability of being labeled accurately by the ML model. Such records are considered “higher priority” based on the expected greater accuracy of labeling. Depending on the implementation, several querying strategies may be used in parallel, with the most accurate strategy then being used to refine the model.

In Phase 2, the queried records are sent to the oracle module, which is another custom algorithm that labels records by projecting their features into a multidimensional mathematical space (e.g., one feature per axis), and labeling it using distance matrix and complex clustering logic. Once a data record is labeled, it is merged into the labeled data pool, and the entire process (Phase 1 and Phase 2) is repeated again, until all of the unlabeled records have been labeled.

In Phase 3, the training module creates a second, final machine learning model using the entire dataset. Since it incorporates every record, whether originally labeled or unlabeled, this final ML model has much greater prediction accuracy than the initial model.

The present disclosure aids substantially in training of machine learning models, by improving the ability to train using low-labeled datasets, without the need for human intervention to label the unlabeled records. Implemented on a processor in communication with a database, the active machine learning labeling system disclosed herein provides a practical way to make use of low-labeled training data while providing a final prediction accuracy comparable to, or superior to, that of systems trained with human-labeled data. This improved training methodology transforms a slow, labor-intensive, error-prone process into one that can occur in near-real time, without the normally routine need for a human expert to label the data by hand. This unconventional approach improves the functioning of the processors running the machine learning model, by reducing training times, improving training accuracy, and improving the quality of the predictions made by the machine learning model.

The active machine learning labeling system may be implemented as a system at least partially viewable on a display, and operated by a control process executing on a processor that accepts user inputs from a keyboard, mouse, or touchscreen interface, and that is in communication with one or more databases stored in memory. In that regard, the control process performs certain specific operations in response to different inputs or selections made at different times. Certain structures, functions, and operations of the processor, display, sensors, and user input systems are known in the art, while others are recited herein to enable novel features or aspects of the present disclosure with particularity.

These descriptions are provided for exemplary purposes only, and should not be considered to limit the scope of the active machine learning labeling system. Certain features may be added, removed, or modified without departing from the spirit of the claimed subject matter.

### Glossary

AML—Anti-money laundering
IFM—Investigations and Fraud Management
LP—Label Propagation
WLX—Watch list filtering
GNR—Global Name Recognition
ML—Machine Learning
API—Application Program Interface
Org—Organization
PEP—Politically Exposed Persons
RCA—Relatives and Close Associates
SIP—Special Interest Person
SIE—Special Interest Entities

For the purposes of promoting an understanding of the principles of the present disclosure, reference will now be made to the embodiments illustrated in the drawings, and specific language will be used to describe the same. It is nevertheless understood that no limitation to the scope of the disclosure is intended. Any alterations and further modifications to the described devices, systems, and methods, and any further application of the principles of the present disclosure are fully contemplated and included within the present disclosure as would normally occur to one of ordinary skill in the art to which the disclosure relates. In particular, it is fully contemplated that the features, components, and/or steps described with respect to one embodiment may be combined with the features, components, and/or steps described with respect to other embodiments of the present disclosure. For the sake of brevity, however, the numerous iterations of these combinations will not be described separately.

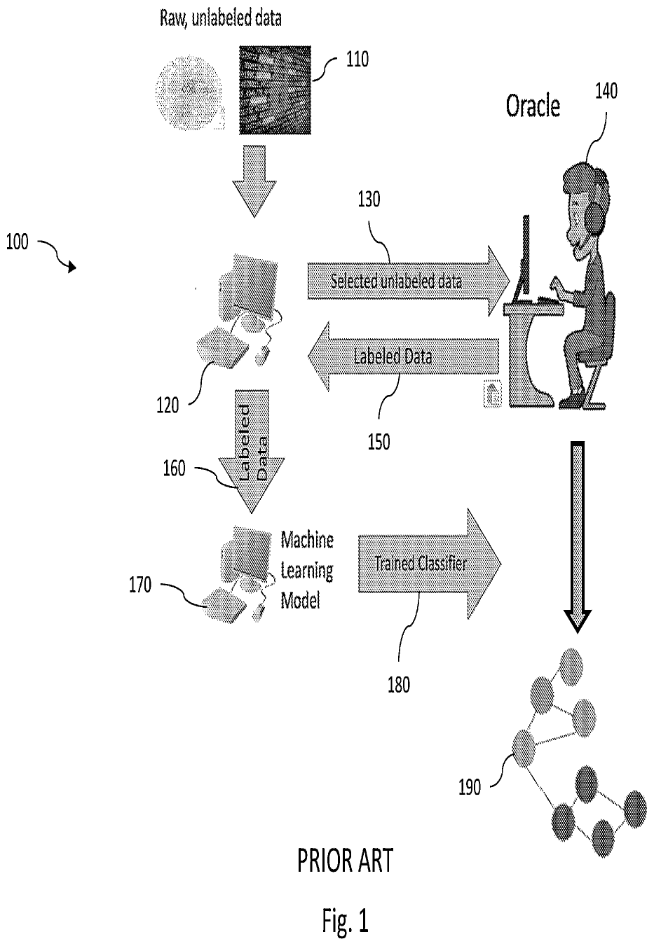

FIG. 1 is a representation, in block diagram form, of at least a portion of an example present-day training process 100 for a machine learning model 180, according to aspects of the present disclosure. In this example, FIG. 1 shows the data flow among different components of the training process in the context of watch list filtering, although similar systems may be applied to other problems in the real world.

In the example shown in FIG. 1, raw unlabeled data 110 is received by a processor or computing system 120, where selected unlabeled data 130 (possibly the entire dataset, although usually a small subset of it) is sent to an “oracle” 140. The oracle 140 may be a human subject matter expert who is trained to label the incoming records, for example by indicating whether or not the originator of a transaction is on a fraud watchlist. Such determinations can be difficult, as data about the originator may be incomplete, or may have some commonalities and some differences from an entity on a watchlist. In an example, the name of an originator may match a watch-listed entity, whereas the address and phone number may be different. In such cases, the oracle 140 may need to do additional research based on other identifying information, and/or may need to apply human judgment in order to classify and label the data record.

The oracle 140 supplies labeled data 150 to the processor or computing system 120, which may perform additional formatting or feature management. The formatted labeled data 160 is then used to train an ML model 170, resulting in a trained ML model 180, also known as a classifier. Any remaining unlabeled data 110 can then be fed into the trained classifier 180 for labeling, resulting in a fully labeled dataset 190.

Because this process relied on a human oracle 140, it may be inherently slow, inefficient, labor-intensive, costly, and/or error-prone.

As to the remaining FIGURES, it is noted that block diagrams are provided herein for exemplary purposes; a person of ordinary skill in the art will recognize myriad variations that nonetheless fall within the scope of the present disclosure. For example, block diagrams may show a particular arrangement of components, modules, services, steps, processes, or layers, resulting in a particular data flow. It is understood that some embodiments of the systems disclosed herein may include additional components, that some components shown may be absent from some embodiments, and that the arrangement of components may be different than shown, resulting in different data flows while still performing the methods described herein. It should also be understood that a human might label the first few unlabeled data records to create the low-labeled dataset on which the presently disclosed ML system might then operate.

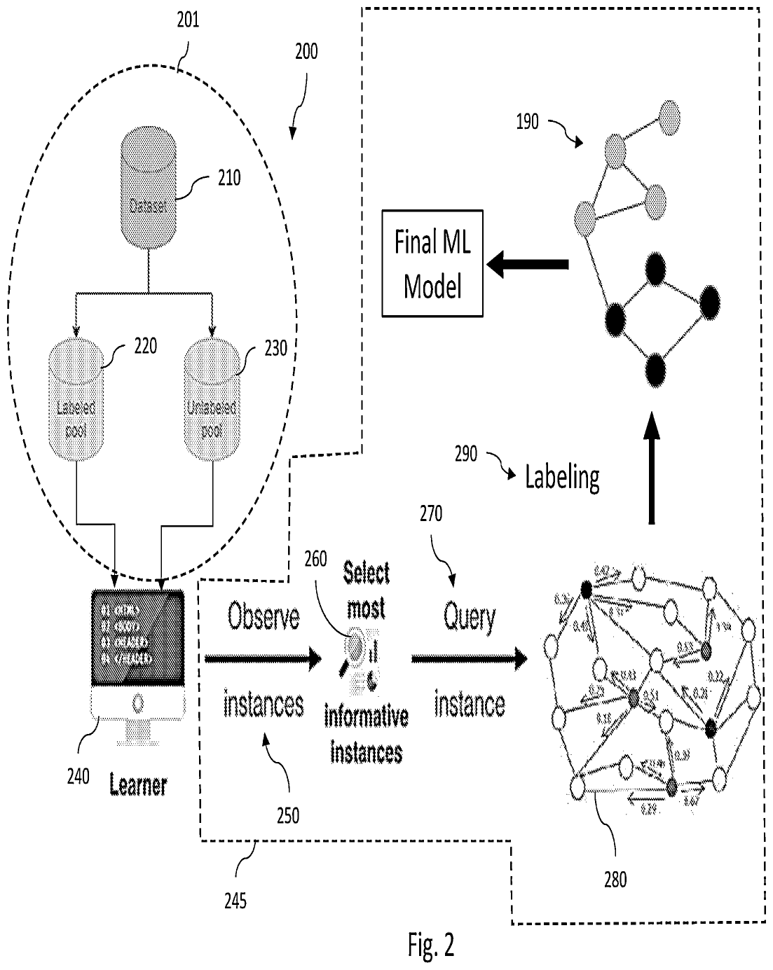

FIG. 2 is a representation, in block diagram form, of at least a portion of an active machine learning labeling system 200, according to aspects of the present disclosure. The active machine learning labeling system 200 includes a data generation module 201. After receiving a raw dataset 210 (e.g., a tuning log containing a large number of records), the data generation module 201 may perform basic cleaning and validation, along with transformation of any features that require it. Some features may require transformation, so the data generation module 201 may perform that task as well. Now the data generation module has a formatted training dataset that can be sorted into labeled data records 220 and unlabeled data records 230, so that the system can learn from patterns in the labeled data 220 and apply that knowledge to label the unlabeled data records 230.

The active machine learning labeling system 200 also includes an active learning module 240. The active learning module 240 takes training set with low-labelled data (e.g., with significantly more unlabeled data 230 than labeled data 220) and builds an initial ML model 250. Accuracy of the initial model may not exceed a desired threshold, as it has been trained on only a small minority of the available data. However, the initial ML model 250 can be used by the active learning module 240 to prioritize the querying of unlabeled data 230 based on a probability score provided by the initial ML model 250, along with a prioritization strategy as described below. In each iteration of the method, based on this priority, the active learning module 240 will choose the highest-priority record or query instance 270 from the prioritized unlabeled records 260, and send it to the label propagation module 245 for labeling.

The active machine learning labeling system 200 also includes a label propagation module 245. The label propagation module 245 takes in the labeled data 220 that was used as training data for the initial ML model 250, along with the selected highest priority record (or query instance) 270, and represents this data in the form of graph 280. Each data record may then be represented as a node, along with edges connecting it to other nodes. Each node is a representation of entity, row, or data record, and it is connected with other nodes using edges, and weights for those edges, based on similarity between the two nodes (e.g., a raw similarity matrix constructed from the data with no modifications). In some embodiments, the label propagation module 245 then iterates on a modified version of the original graph 280 and normalizes the edge weights by computing the normalized graph Laplacian matrix—a procedure that is also used in spectral clustering. A probabilistic transition matrix is thus created, which permits the label propagation module 245 to assign a probability to the currently selected unlabeled record (or query instance) 270, indicating which classification (e.g., watch-listed or non-watch-listed) that record belongs to. In a labeling step 290, the unlabeled record 270 is then labeled according to its classification, and merged into pool of labeled data 220.

The label propagation module 245 then repeats this process until all records in the unlabeled data pool 230 have been labeled and added to the labeled data pool 220. The result is a fully labeled dataset 190, which may be much larger than the original labeled dataset 220, and which may be used to train a final ML model 295 with much greater prediction accuracy than the initial ML model 250.

In an example, the operation of the label propagation module 245 may be as follows. First, the active learning module 240 is used to train the initial ML model 250 from labeled pool data and query record from unlabeled pool. Some example steps are listed below. First, the active learning module 240 trains the initial ML model 250 on a very small subsample of data which are labeled. The accuracy of the initial ML model may only be moderate, but it will help the label propagation model to identify some patterns. After the model is trained, the label propagation module 245 can use the model to predict the class probability of each unlabeled data point (e.g., the probability that it belongs to a particular class such as “watch-listed”) from the unlabeled pool, giving a probability score to each unlabeled data point based on the prediction of the base model. Next, the label propagation module 245 can query the unlabeled records one at a time, in an order determined by a querying strategy.

One possible querying strategy is “least confidence” querying, which takes the highest probability for each data point's prediction and sorts them from smaller to larger. The actual expression to prioritize using least confidence would be:

$${S}_{LC} = arg max ( 1 - P ( \hat{y} \vert x ) ) \qquad ( Eqn . 1 )$$

Where P(ŷ|x)) is the probability of y given x. Another possible querying strategy is margin sampling, which takes into account the difference between the highest probability and the second highest probability. Formally, the expression to prioritize would look like:

$${S}_{Ms} = arg min ( P ( {\hat{y}}_{max} \vert x ) - P ( {\hat{y}}_{max - 1} \vert x ) ) \qquad ( Eqn . 2 )$$

Still another possible querying strategy is entropy sampling, which prioritizes data points with higher entropy over the ones with lower entropy. Entropy may be calculated using:

$${S}_{E} = arg max ( - {\sum }_{i}^{n} P ( \hat{y} \vert x ) log P ( \hat{y} \vert x ) ) \qquad ( Eqn . 3 )$$

In some embodiments, multiple sampling strategies may be tested on small groups of records (e.g., 10-20 records at a time), and the best (e.g., most accurate) strategy selected. Once the best approach has been chosen to prioritize the labeling, the unlabeled records in the subset can be labeled by querying, classifying, and labeling the records one at a time. The label propagation module then trains a new ML model on the fully labeled data subset. Once the new model has been trained on the subset of data, the remaining unlabeled data points can be run through the model to update the prioritization scores to continue labeling. In this way, the label propagation module can keep optimizing the labeling strategy as the models become better and better.

Within the label propagation module, a label generation routine may receive the latest queried record, and create a connected graph 280 by drawing edges (links) between different nodes (data points). However, creating a fully connected graph on an entire dataset may demand a high amount of computing resources. Hence, it is often beneficial to limit the number of neighbors that are joined to the queried record. Next, the label generation routine determines the weights for each edge, where edges for closer data points have larger weights (e.g., stronger connections), and edges for faraway points have smaller weights (e.g., weaker connections). Larger edge weights allow labels to travel through the graph more easily, thus increasing the probability of propagating the particular label. To that end, a probabilistic transition matrix is created so that a random walk can be performed. The probabilistic transition matrix may for example be expressed as:

$$[ \begin{matrix}{y}_{l} \\ {y}_{u}\end{matrix} ] = [ \begin{matrix}I & 0 \\ {( I - {T}_{uu} )}^{- 1} \cdot {T}_{ul} & 0\end{matrix} ] [ \begin{matrix}{y}_{l} \\ 0\end{matrix} ] \qquad ( Eqn . 4 )$$

Where yₗ is a labeled node, and yᵤ is an unlabeled node, and

$$Label for xi = arg max ( {y}_{u} [ i ] ) \qquad ( Eqn . 5 )$$

The label generation routine then performs a random walk from each unlabeled node to find a probability distribution of reaching a labeled node. This random walk may consist of many iterations, and may continue until convergence is rcached, e.g., until all paths have been explored, and probabilities no longer change (or no longer change in a statistically significant manner).

Thus, a system for automatically labeling data records includes a processor configured to receive a set of low-labeled data records (some labeled as watch-listed, some labeled as non-watch-listed, and the vast majority not labeled at all), and to use the features of the labeled records to train an ML model. The ML model is then used to assign probabilities to the unlabeled records as to whether they are watch-listed or not. A label propagation algorithm then processes the unlabeled records one at a time (with the order of selection based on a decision criterion) by labeling them, adding them to the pool of labeled data, and updating the training of the ML model. This process continues until all unlabeled records have been labeled.

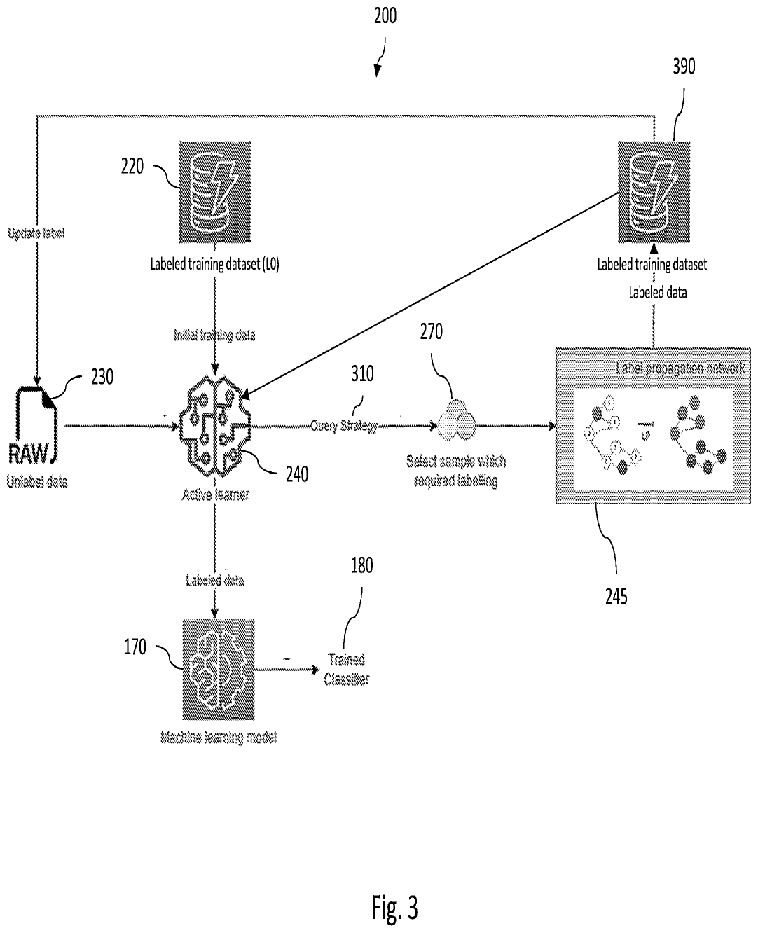

FIG. 3 is a representation, in block diagram form, of at least a portion of an active machine learning labeling system 200, according to aspects of the present disclosure. In the example shown in FIG. 3, the active machine learning labeling system 200 includes a raw unlabeled dataset 230 and a labeled training dataset 220, both of which are received by the active learning module 240 to train a machine learning model 170 into a trained classifier 180. The active learning module 240 also uses a query strategy 310 to select an unlabeled data record 270 from the unlabeled data 230 for processing by the label propagation module 245. Possibly query strategies include, but are not limited to: least confidence, margin sampling and entropy-based sampling. The label propagation module 245 generates a label for the unlabeled data record and then adds the newly labeled record to an enhanced labeled data set 390, which is then iteratively passed to the active learning module 240 and deleted from the unlabeled dataset 230 until all unlabeled data records have been processed (e.g., until the unlabeled dataset 230 is empty).

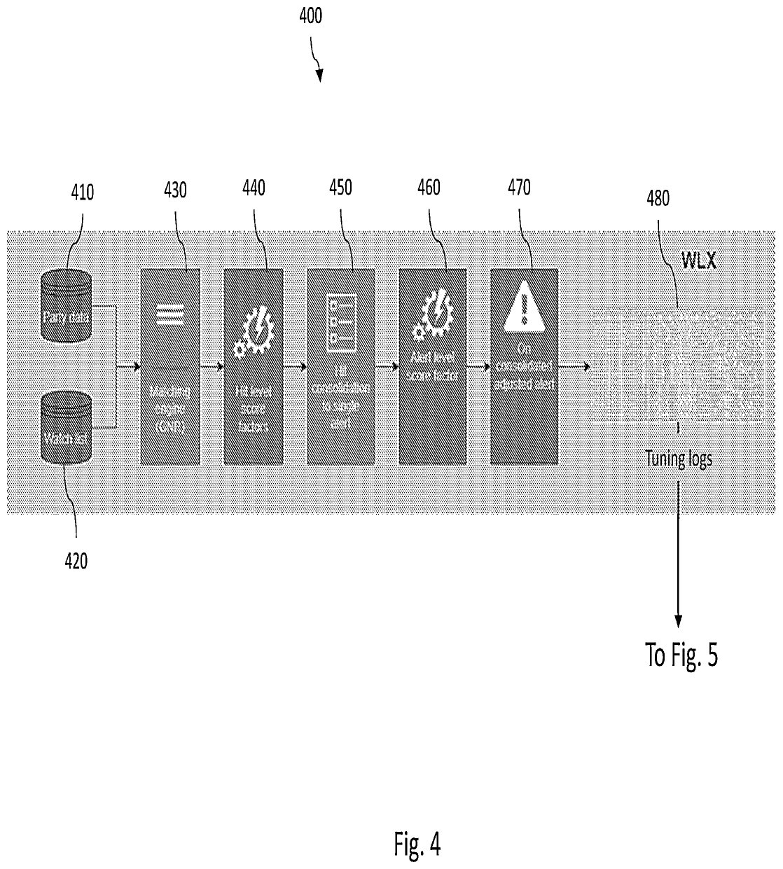

FIG. 4 is a representation, in block diagram form, of at least a portion of a watch list filtering system 400, according to aspects of the present disclosure. The watch list filtering system compares entity names against a sanction list or watchlist maintained internally by an institution (e.g., a bank) or retrieved from an external entity. The match list filtering system may for example screen a party name against the entirety of a sanction list via a tool such as the IBM GNR API. GNR will return hits and corresponding hit scores, to which the watch list filtering system may apply one or more additional scoring factors to obtain a final hit score (e.g., a probability that the entity generating this particular transaction record is in fact on the watch list). Based on this final hit score, a filter can set alert flags for those records having the maximum score. A tuning log is generated by this process.

The watch list filtering system 400 includes the party data or transaction record data 410 and a watch list 420, which are fed to a matching engine 430 such as GNR, whose output is annotated with additional hit score factors 440 and then consolidated into a single alert, for which an alert score factor 460 is generated that, if it exceeds a threshold, generates an alert flag 470. Data from each step of this process may be added to the tuning log 480. The tuning log 480 contains “features” for each data record, that can then be used to generate a machine learning model as described above.

A list of possible features in this embodiment includes, but is not limited to:
Party Countries
Party Year of Birth
Party Type
Party Gender
Hit Countries
Hit Year of Birth
Hit Gender
Lists
Hit Keywords
Hit Categories
Matching Engine Match score
Match Type
Id Match
Id Match Score
Low Quality Aliases
Low Quality Aliases Score
Country Match
Country Match Score
No. of Keywords
No. of Keywords Score
Low Risk Categories
Low Risk Categories Score
Low Risk Keywords
Low Risk Keywords Score
Single Token Match
Single Token Match Score
Org Exact Match
Org Exact Match Score
Person Exact Match
Person Exact Match Score
Local Country Match
Local Country Match Score
Year of Birth Match
Year of Birth Match Score
Gender Match
Gender Match Score
Prior Hits Frequency
Prior Hits Frequency Score
Prior Hits—Issue
Prior Hits—Issue Score
Prior Hits—Non-Issue
Prior Hits—Non-Issue Score
Prior Hits—Non-Determination
Prior Hits—Non-Determination Score
Edit Distance Match
Edit Distance Match Score
No.of Initial Hits
No.of Initial Hits Score
Is Org
Is Org Score
Is Person
Prior Alerts—Issue
Prior Alerts—Issue Score
Prior Alerts—Non-Issue
Prior Alerts—Non-Issue Score
Prior Alerts—Non-Determination
Prior Alerts—Non-Determination Score
Hit Suppressed
Hit Exclude
Raw Hit Score
Total Hit Score
Alert Score
Is Normalized Score
Algorithm
Matched_on_full_Name
matched on first name
matched on last name
Party_aliases_present
Hit_aliases_present
Party_Alias_count
Hit_Alias_count
min_hit_match_score_with_alias
max_hit_match_score_with_alias
min_party_match_score_with_alias
max_party_match_score_with_alias
hit_id_present
party_id_present
party_id_type
hit_id_type
count_of_categories
is_PEP
is_RCA
is_SIP
is_SIE

A person of ordinary skill in the art will appreciate that other variables or features may be included in the tuning log 480 instead of or in addition to those listed herein. Depending on the implementation, the tuning log 480 may include between two and several hundred features for each data record, although a range of between 45 and 80 features may be preferred. The tuning log(s) 480 may then be received by a data generation module as shown below.

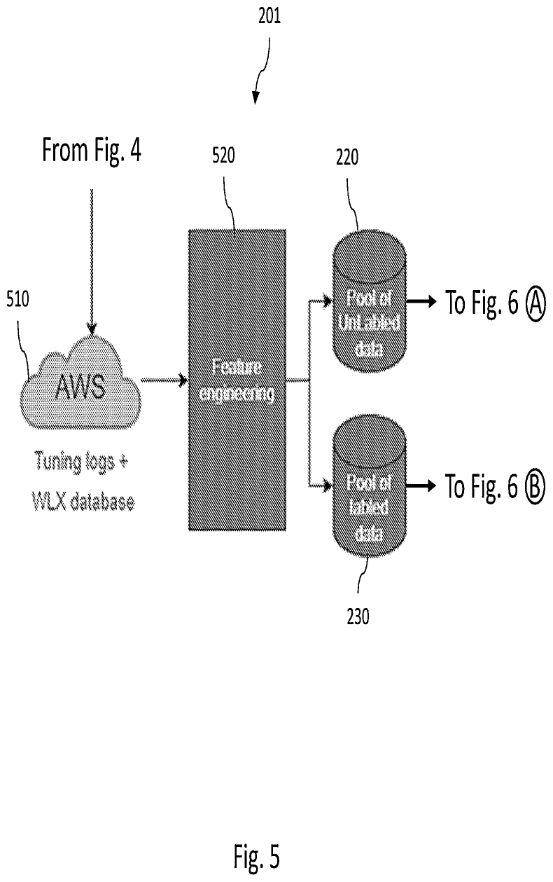

FIG. 5 is a representation, in block diagram form, of at least a portion of an example data generation module 201 of an active machine learning labeling system 200, according to aspects of the present disclosure. The data generation module 201 receives one or more tuning logs 480 (see FIG. 4) and stores them in a database 510 (e.g., located on a cloud service such as Amazon Web Services), possibly along with other data from the transaction records that was not included in the tuning logs. Derived features may also be computed at this step (e.g., resolving a geographic latitude/longitude or IP address into a city of origin, etc.) and included in the database 510, along with any labels (e.g., notes added by a human analyst) that may be available.

A feature engineering step then arranges and formats the data that is deemed relevant to the active machine learning labeling system 200, and sorts each record into either the labeled data pool 220 or the unlabeled data pool 230.

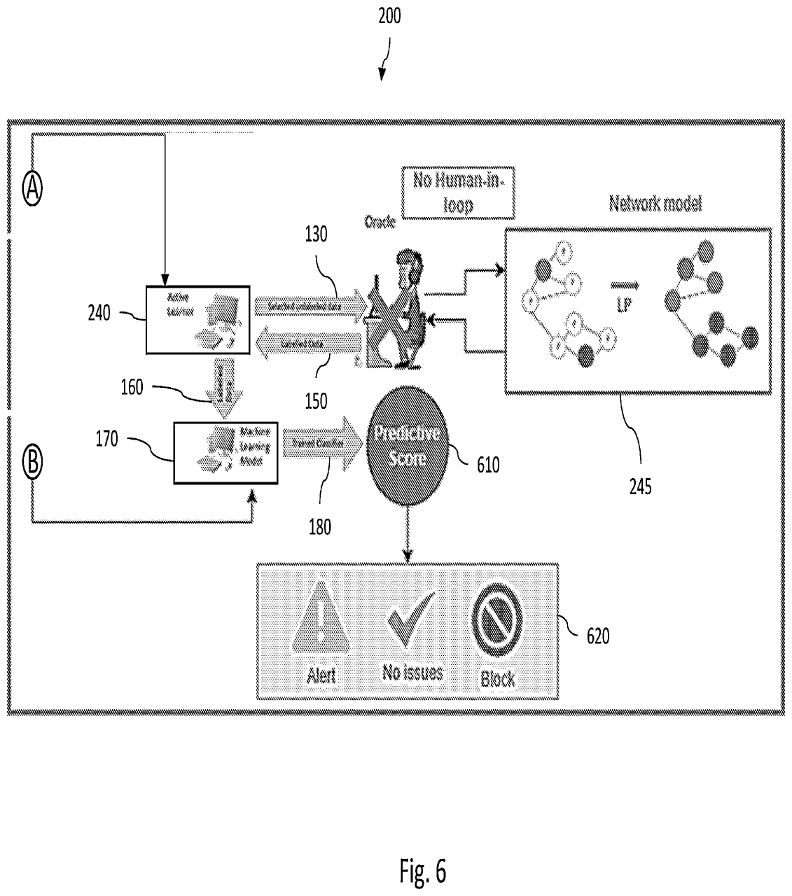

FIG. 6 is a representation, in block diagram form, of at least a portion of an active machine learning labeling system 200, according to aspects of the present disclosure. In the example shown in FIG. 6, the active machine learning labeling system 200 receives a labeled dataset 220 (see FIG. 5), and uses it to train an ML model 170. The active machine learning labeling system 200 also receives an unlabeled dataset 230 (see FIG. 5), which is received by the active learning module 240, which passes selected unlabeled data records 130 one at a time to the label propagation module 245. At each iteration, the label propagation module 245 labels the unlabeled data record 130 and adds it to the pool of labeled data 160. When all of the unlabeled records 130 have been labeled, the machine learning model 170 is re-trained using the completed pool of labeled data 160, thus producing a trained classifier 180.

The trained classifier 180 is then capable of generating a predictive score 610 for any new records received by the active machine learning labeling system 200 (e.g., indicating the probability that the entity generating a given record is watch-listed). The trained classifier 180 will thus rank all the “hits” (suspected fraudulent transactions), and in some embodiments the active machine learning labeling system 200 can then elevate all positive hits suggested by model and suppress false positives by defining probability scores below a defined threshold value as being false positives. The predictive score 610 can then be used to generate a recommendation 620. Example recommendations include Alert (e.g., forward the transaction to a human investigator for further analysis), No Issues (e.g., allow the transaction), or Block (e.g., automatically prevent the transaction from completing). Other recommendations based on the predictive score 610 may be generated instead or in addition, without departing from the spirit of the present disclosure.

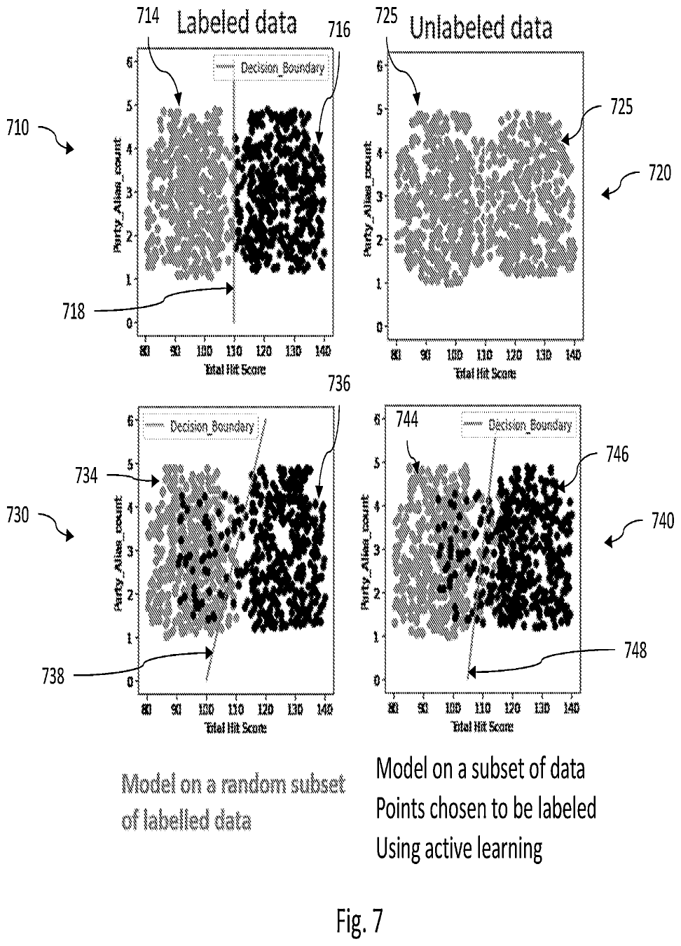

FIG. 7 is a comparison of four scatterplots showing the performance of the active machine learning labeling system 200, according to aspects of the present disclosure. The scatterplots may for example be two-dimensional projections of a multidimensional space, wherein the multidimensional space includes one axis for each feature or variable being analyzed (e.g., a 5-dimensional space, in the case that 5 features are included in the ML model). A person of ordinary skill in the art will appreciate that the ML model may include anywhere from 2 to several hundred features, although to provide good performance while avoiding overfitting, between 25 and 30 features may be used. The 2D projections for each scatterplot may for example be along the eigenvectors of the multidimensional space, such that the 2D spacing of data points is maximized for clarity.

A scatterplot 710 of the labeled dataset shows data records with a first classification 714 (e.g., non-watch-listed, light gray) and data records with a second classification 716 (e.g., watch-listed, dark gray). The two classifications 714 and 716 are separated by a decision boundary 718, indicating a line in the two-dimensional space wherein all members of the first classification fall on one side of the line, and all members of the second classification fall on the other side of the line.

A scatterplot 720 of the unlabeled dataset shows a plurality of unlabeled data records 725, whose proper classification is as yet unknown.

A scatterplot 730 shows the classification outputs of an ML model trained on a random subset of the labeled data. Visible are data points of the first classification 734 (e.g., non-watch-listed, light gray), data points of the second classification 736 (e.g., watch-listed, dark gray), and a decision boundary 738 selected by the ML model. As can be seen, most data points of the first classification 734 fall on the left side of the decision boundary 738, and most data points of the second classification 736 fall on the right side of the decision boundary 738. However, some “false negative” data points of the second classification 736 fall to the left of the decision boundary 738, and some “false positive” data points of the first classification 734 fall to the right of the decision boundary 738. The accuracy of the ML model can be measured by the number of false positive and false negative results and the size of the dataset.

A scatterplot 740 shows the classification outputs of an ML model trained on a subset of data points chosen to be labeled using active learning and label propagation or label spreading, as described herein. Visible are data points of the first classification 744 (e.g., non-watch-listed, light gray), data points of the second classification 746 (e.g., watch-listed, dark gray), and a decision boundary 748 selected by the ML model. As can be seen, fewer “false negative” data points of the second classification 736 fall to the left of the decision boundary 738, and fewer “false positive” data points of the first classification 734 fall to the right of the decision boundary 738, as compared with scatterplot 730. Thus, the ML model trained using active learning and label propagation can be more accurate than the model trained on random data.

Furthermore, as shown below, the accuracy of the label propagation method increases as more data records are classified and labeled. Label propagation and label spreading are very similar paradigms, whose primary difference lies in the design of the transition matrix. For example, label propagation may use the graph Laplacian in its calculations, while label spreading may use a random walk normalized graph Laplacian.

During label propagation or label spreading, it may be advantageous to prioritize unlabeled data points based on their distance from the decision boundary of the labeled dataset. Specifically, it may be particularly advantageous to first classify those data records that are closest to the decision boundary, as once these data points are labeled, the system can label farthest point quickly in batches, which may help speed up the algorithm and conserve computing resources.

Once the system has queried one unlabeled record, a request is sent to the label propagation model to fetch or generate a label for that unlabeled record. Once the label is generated, that record is added to the labeled dataset, and can be used in the decision process for labeling records thereafter.

In some embodiments, a decision criterion is used for determining the order in which to process the unlabeled records. The decision criterion may for example include whether a majority of the labeled neighbors within a given search radius are labeled as having the particular characteristic. Instead or in addition, the decision criterion may include determining whether a weighted majority of the labeled neighbors are labeled as having the particular characteristic, where the weighting is based on a distance between the selected record and each respective labeled neighbor within the multidimensional feature space. Other decision criteria may be applied instead or in addition to those shown herein.

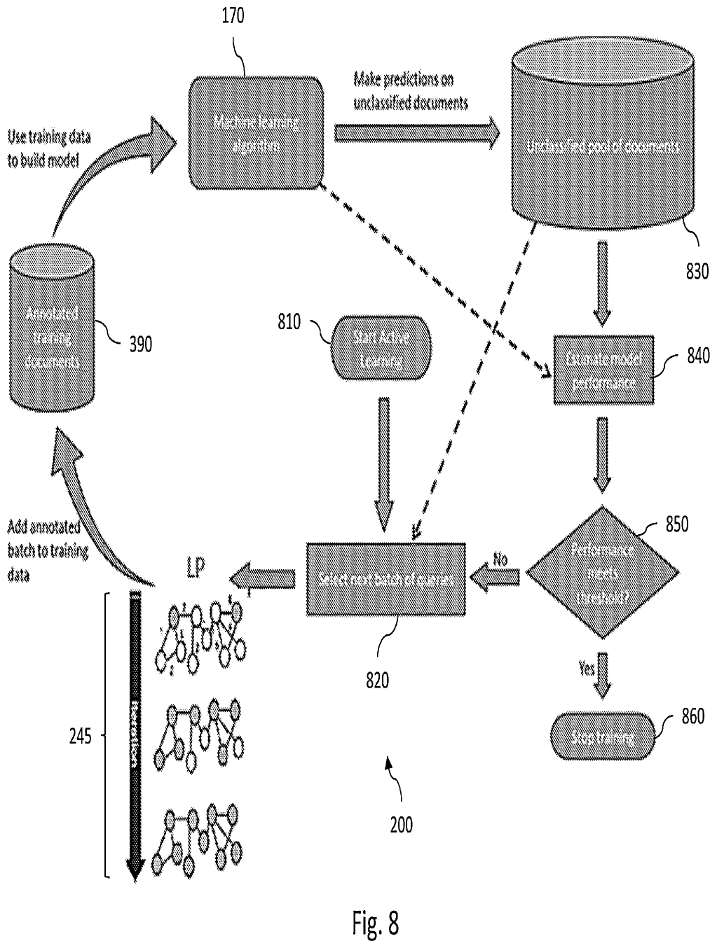

FIG. 8 is a representation, in a hybrid block/flow diagram form, of at least a portion of an active machine learning labeling system 200, according to aspects of the present disclosure.

At step 810, the active machine learning labeling system 200 initiates the active learning process as described above.

At step 820 the active machine learning labeling system 200 queries a new batch of unlabeled records (e.g., 10 records, 20 records, 50 records, etc.) from the remaining pool of unlabeled records. These queried unlabeled records are then sent to the label propagation module 245, which classifies them, labels them, and adds them to the training data, e.g., the pool of labeled data records 390. The training data 390 is then used to train a machine learning algorithm or ML model 170, which is used to make predictions about the classification of the pool of remaining unlabeled records 830.

At step 840, the active machine learning labeling system 200 estimates the prediction accuracy of the ML model 170 as described above.

At step 850, the active machine learning labeling system 200 determines whether the estimated prediction accuracy meets or exceeds a specified performance threshold. If yes, execution proceeds to step 860. If no, execution returns to step 820. In some embodiments, execution may also proceed to step 860 if no records remain in the unlabeled data pool 830.

At step 860, the active machine learning labeling system 200 stops training the ML model. The active learning process is now complete.

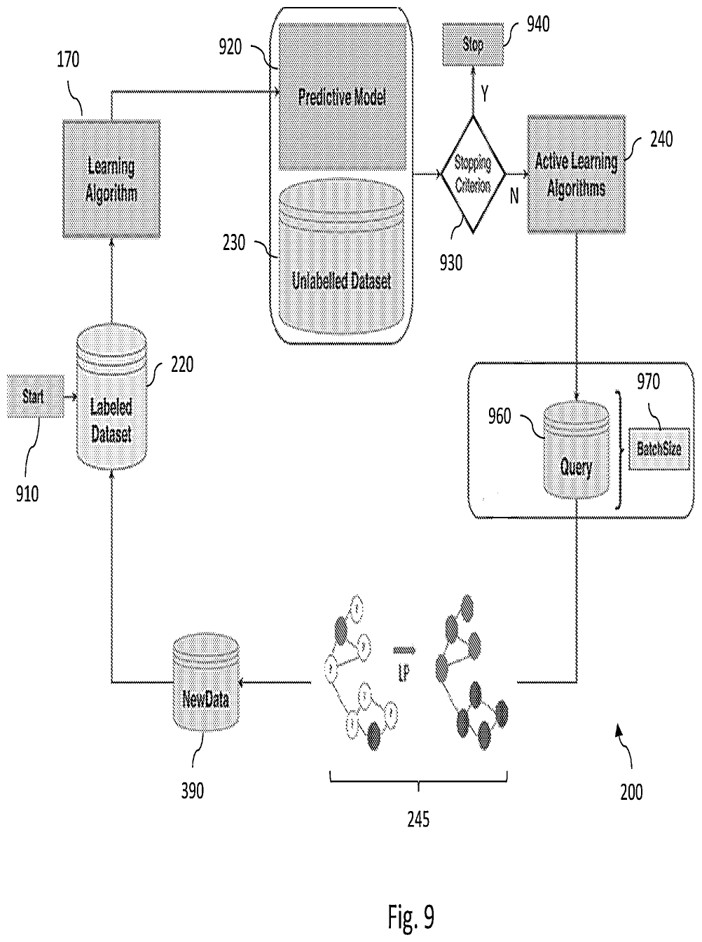

FIG. 9 is a representation, in a hybrid block/flow diagram form, of at least a portion of an active machine learning labeling system 200, according to aspects of the present disclosure.

At step 910, the active machine learning labeling system 200 receives the labeled dataset 220, and uses it to train the learning algorithm or ML model 170, thus yielding a predictive model 920, which is used to assign classification probabilities to each record within the unlabeled dataset 230.

At step 930, the active machine learning labeling system 200 evaluates whether a stopping criterion has been met. This may for example be a performance threshold or accuracy threshold for the predictive model 920, or it may occur when no unlabeled records remain in the unlabeled dataset 230. If the stopping criterion has been met, execution proceeds to step 940. If the stopping criterion has not been met, the active machine learning labeling system 200 then initiates the active learning module 240, which uses a querying strategy to query a batch of unlabeled records 960 with a batch size 970. This batch of unlabeled data records 960 is then passed to the label propagation module 245, where it is classified and labeled. The labeled batch 390 is then added to the labeled dataset 220, where the depicted process is repeated as described above.

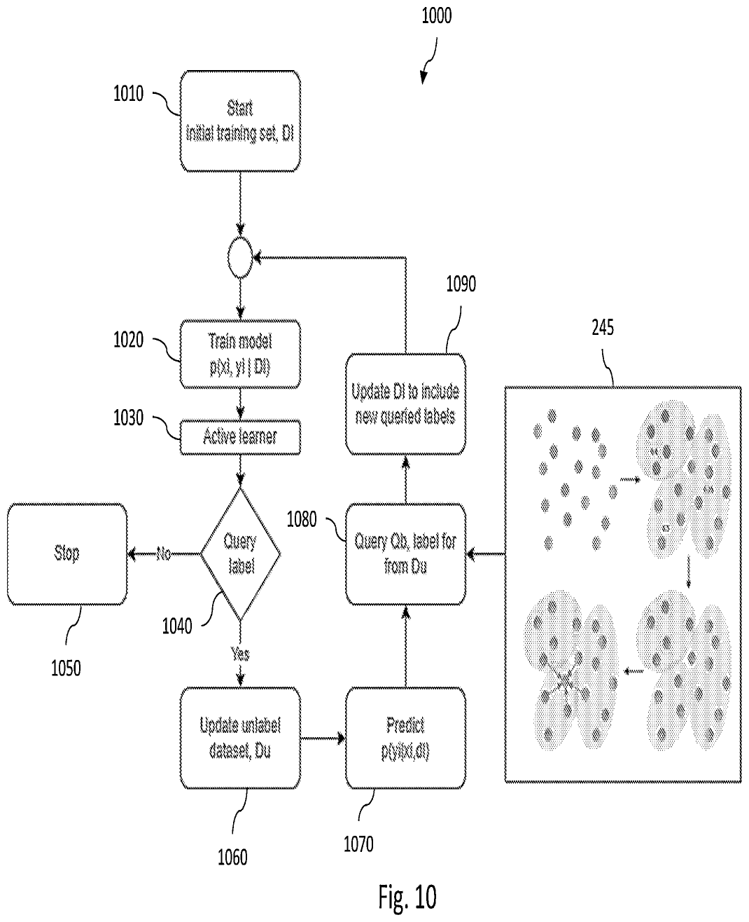

FIG. 10 is a representation, in flow diagram form, of at least a portion of an example active machine learning labeling method 1000, according to aspects of the present disclosure.

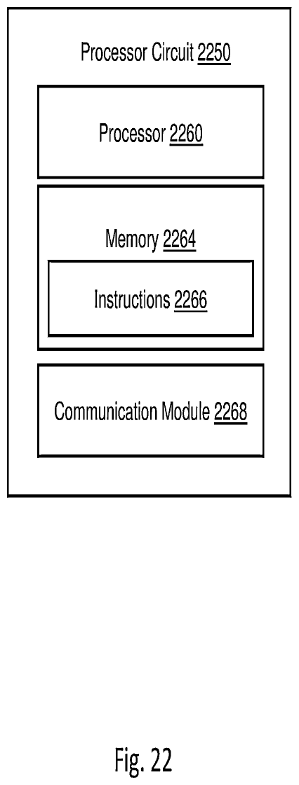

It is understood that the steps of the methods described herein may be performed in a different order than shown or described. Additional steps can be provided before, during, and after the steps as shown, and/or some of the steps shown or described can be replaced or eliminated in other embodiments. One or more of steps of the methods can be carried by one or more devices and/or systems described herein, such as components of the active machine learning labeling system 200 and/or processor circuit 2250 (see FIG. 22).

In step 1010, the method 1000 includes receiving the initial labeled training dataset D1.

In step 1020, the method 1000 includes training the model Model {p(xi,yi|D1)} is with initial training dataset D1.

In step 1030, the method 1000 includes activating the active learner module.

In step 1040, the method 1000 includes querying a batch of unlabeled data from the unlabeled dataset Du. If no unlabeled data remains, execution proceeds to step 1050. Otherwise, execution proceeds to step 1060.

In step 1050, the method 1000 is complete.

In step 1060, the method 1000 includes updating the unlabeled dataset Du to remove the queried records.

In step 1070, the method 1000 includes predicting classification probabilities for the queried records, with a probability score assigned here help active learner to query records which need labeling first, as described above.

In step 1080, the method 1000 includes selecting unlabeled records one by one from the queried records (based on the probability score and selected query strategy), and generating labels for them via the label propagation module 245. Here the objective is to choose the unlabeled data smartly so that with minimum querying, the system can label the entire dataset and build a robust ML model.

In step 1090, the method 1000 includes updating the labeled dataset D1 to include the new labeled data. Execution then returns to step 1020.

It is noted that the flow diagrams provided herein are for exemplary purposes; a person of ordinary skill in the art will recognize myriad variations that nonetheless fall within the scope of the present disclosure. The logic of the methods may for example be shown as sequential. However, similar logic could be parallel, massively parallel, object oriented, real-time, event-driven, cellular automaton, or otherwise, while accomplishing the same or similar functions. In order to perform the method, a processor circuit (e.g., processor circuit 2250 of FIG. 22) may divide each of the steps described herein into a plurality of machine instructions, and may execute these instructions at the rate of several hundred, several thousand, several million, or several billion per second, in a single processor or across a plurality of processors. Such rapid execution may be necessary in order to execute one or more of the methods in real time or near-real time as described herein. For example, in some embodiments, the system may need to perform computationally intensive label propagation calculations in near-real time, in order to sort the unlabeled data into classifications, generate appropriate labels, and re-train the machine learning model for further operation.

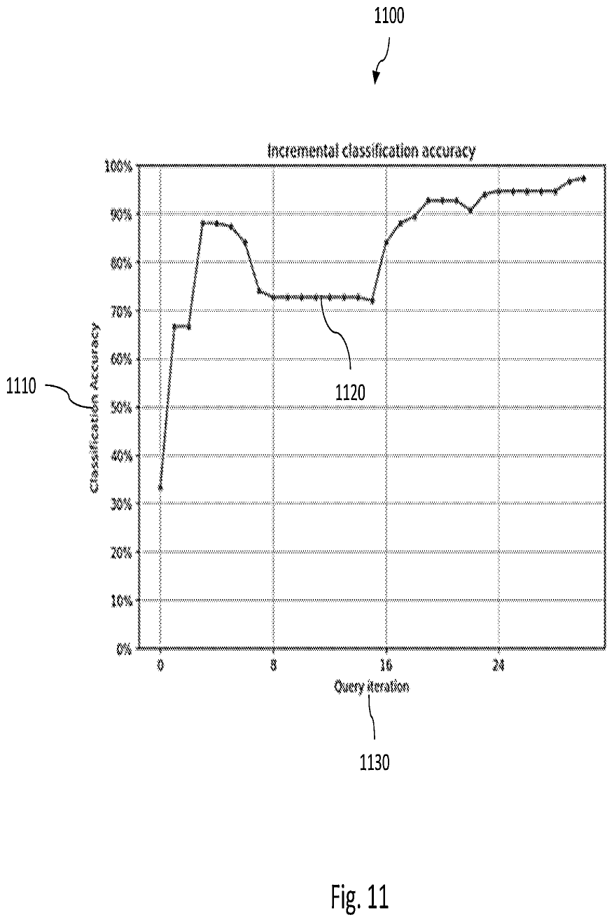

FIG. 11 is a graph 1100 showing classification accuracy over time for an ML model of the active machine learning labeling system 200, according to aspects of the present disclosure. The graph 1100 plots classification accuracy 1110 vs. the number of query iterations that have taken place 1130. As can be seen by curve 1120, the classification accuracy is initially no better than chance. However, accuracy rises to greater than 95% by the 30^{th} iteration, due to the active learning strategy, system, and methods described herein.

Various querying strategies can affect not only the final accuracy of the model, but also the time required to achieve that accuracy. Querying strategies may include, but are not limited to, pool-based sampling, ranked batch mode sampling, stream-based sampling, active regression, ensemble regression, queries by committee, Keras classifier, etc. In some embodiments, multiple querying strategies are used in parallel, and the highest-performing strategy is used to train the final ML model.

In an example, a raw dataset may consist of 60,000 “hits” (e.g., transaction attempts suspected of being generated by watch-listed entities), of which 5,000 are labeled as “0” or “false positive” and 1,500 are labeled as “1” or “true positive”. In such a case, the initial model may be trained using only a small fraction of the labeled data, such as 70 or 100 records, with the remained of the labeled data being set aside for validation of the final ML model. Once the 53,500 unlabeled data records are sent to the active machine learning labeling system 200 for labeling, the final ML model trained from the newly labeled data can then be verified against the remaining 6,430 labeled records to gauge the accuracy of the final ML model. Where multiple querying strategies have been employed, the most accurate ML model can then be selected for deployment, and used to evaluate incoming customer transactions in real time or near-real time.

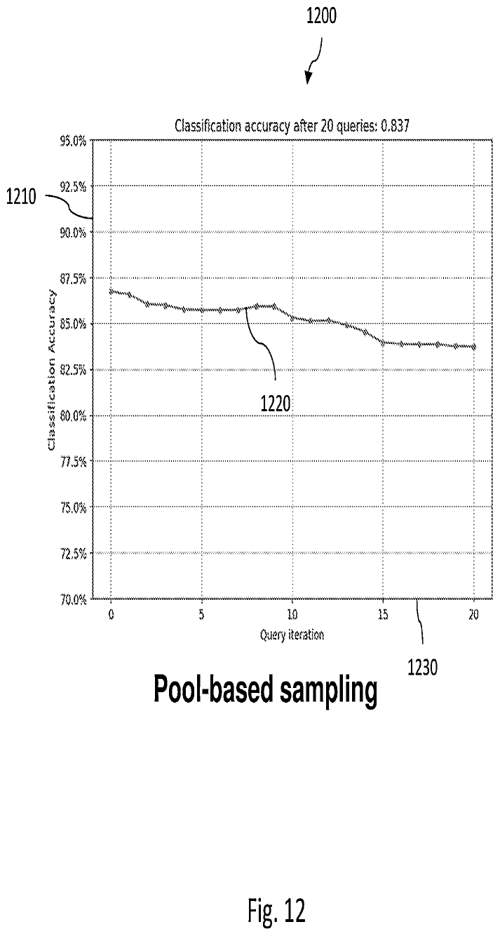

FIG. 12 is a graph 1200 showing classification accuracy over time for an ML model of the active machine learning labeling system 200 using a pool-based sampling strategy, according to aspects of the present disclosure. The graph 1200 plots classification accuracy 1210 vs. the number of query iterations that have taken place 1230. In pool-based sampling, queries are selectively drawn from the unlabeled pool, which is usually assumed to be closed, in a greedy fashion, according to an informativeness measure used to evaluate all instances in the pool. As can be seen by curve 1220, the classification accuracy is initially around 86%. However, accuracy gradually declines to around 83% by the 20th iteration, suggesting that for the particular dataset analyzed in this example, pool-based sampling is not an effective querying strategy.

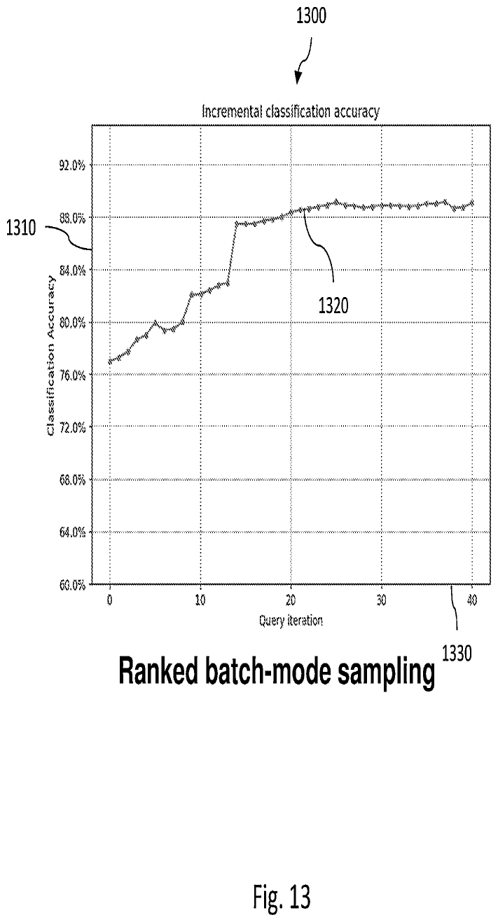

FIG. 13 is a graph 1300 showing classification accuracy over time for an ML model of the active machine learning labeling system 200 using a ranked batch-mode sampling strategy, according to aspects of the present disclosure. The graph 1300 plots classification accuracy 1310 vs. the number of query iterations that have taken place 1330. Ranked batch-mode sampling is an amalgamation of uncertainty and similarity measures to rank datapoints which need labeling first, to account for situations where the system has the resources to label multiple instances at the same time—a situation that classical uncertainty sampling does not support. As can be seen by curve 1320, the classification accuracy is initially around 70%. However, accuracy gradually increases to around 89% by the 40th iteration, suggesting that for the particular dataset analyzed in this example, ranked batch-mode sampling is an effective querying strategy.

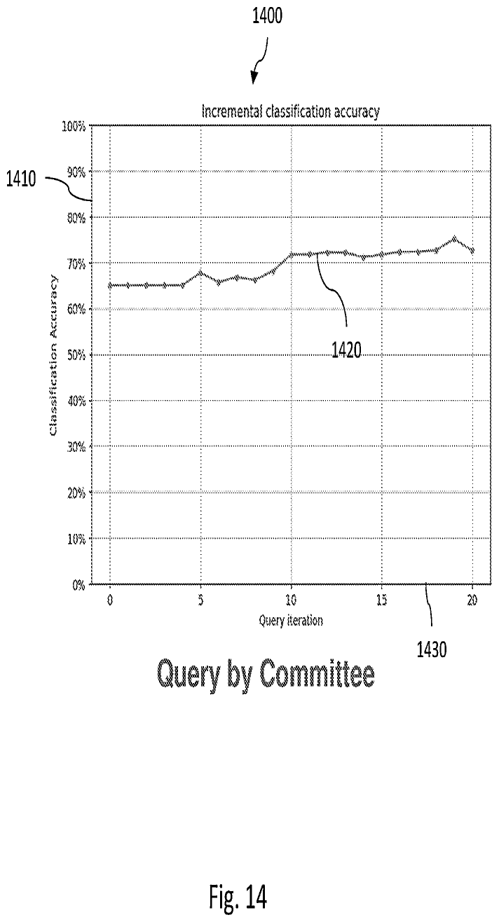

FIG. 14 is a graph 1400 showing classification accuracy over time for an ML model of the active machine learning labeling system 200 using a query-by-committee sampling strategy, according to aspects of the present disclosure. The graph 1400 plots classification accuracy 1410 vs. the number of query iterations that have taken place 1430. Query-by-committee sampling is another strategy which overcomes some of the problems identified in uncertainty sampling, such as missing important instance which are not in the sight of the estimator, or disagreement on choosing instances. As can be seen by curve 1420, the classification accuracy is initially around 65%. However, accuracy gradually increases to around 70% by the 20th iteration, suggesting that for the particular dataset analyzed in this example, pool-based sampling is an effective querying strategy, though not as effective as ranked batch-mode sampling.

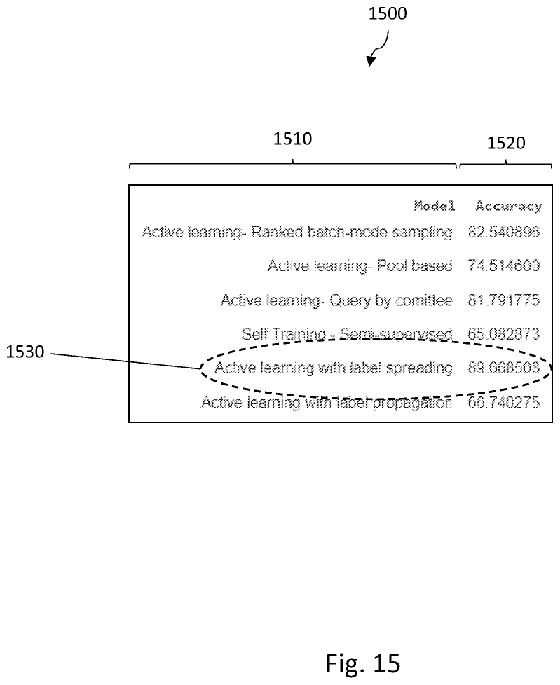

FIG. 15 is a comparison table 1500 showing the accuracies 1520 of different querying strategies 1510 for an example active machine learning labeling system 200, according to aspects of the present disclosure. In the example shown in FIG. 15, for a particular implementation of the active machine learning labeling system 200 using a particular dataset, the “Active learning with label spreading” strategy resulted in the highest overall accuracy of just under 90%. It is understood that for other implementations of the active machine learning labeling system 200 and/or other datasets, different accuracies may be achieved, and a different strategy may therefore be best. Thus, it may be desirable to perform the operations described herein for multiple strategies in parallel, thus generating multiple different ML models. Then, the final ML model selected for field deployment may be the ML model with the highest overall accuracy.

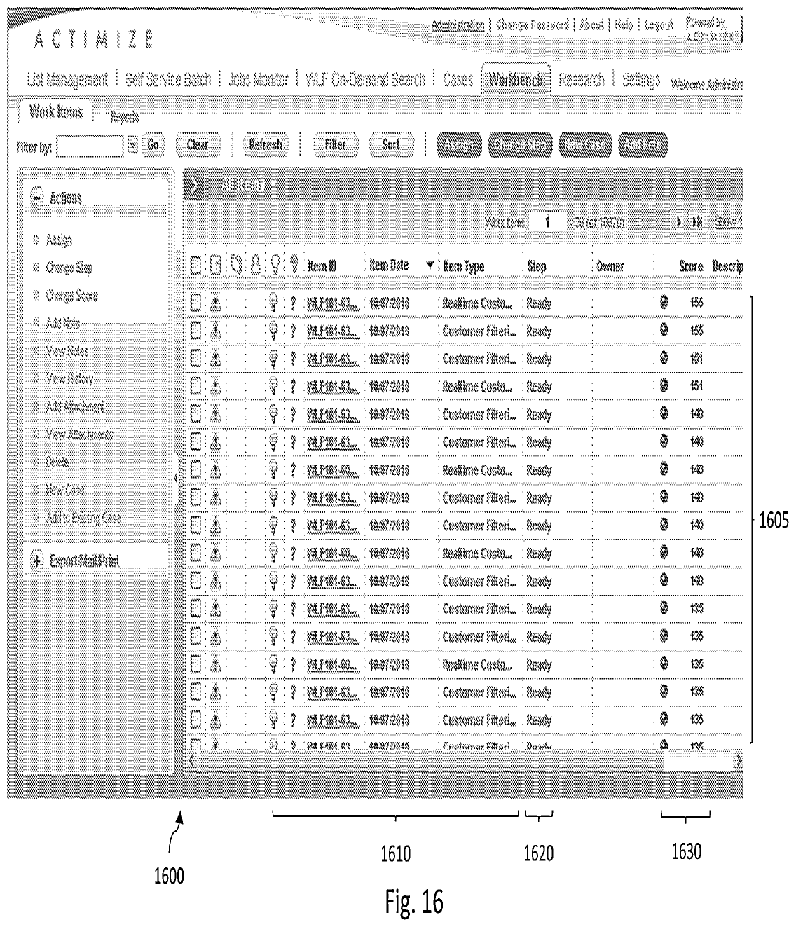

FIG. 16 is an example user interface screen 1600 for an active machine learning labeling system 200, according to aspects of the present disclosure. The user interface screen includes a plurality of records 1605, each of which includes identifying information 1610 (e.g., a name, date, ID number, event type, etc.), status information 1620, and a classification probability score 1630 (e.g., a score indicating a probability that the record was generated by a watch-listed entity).

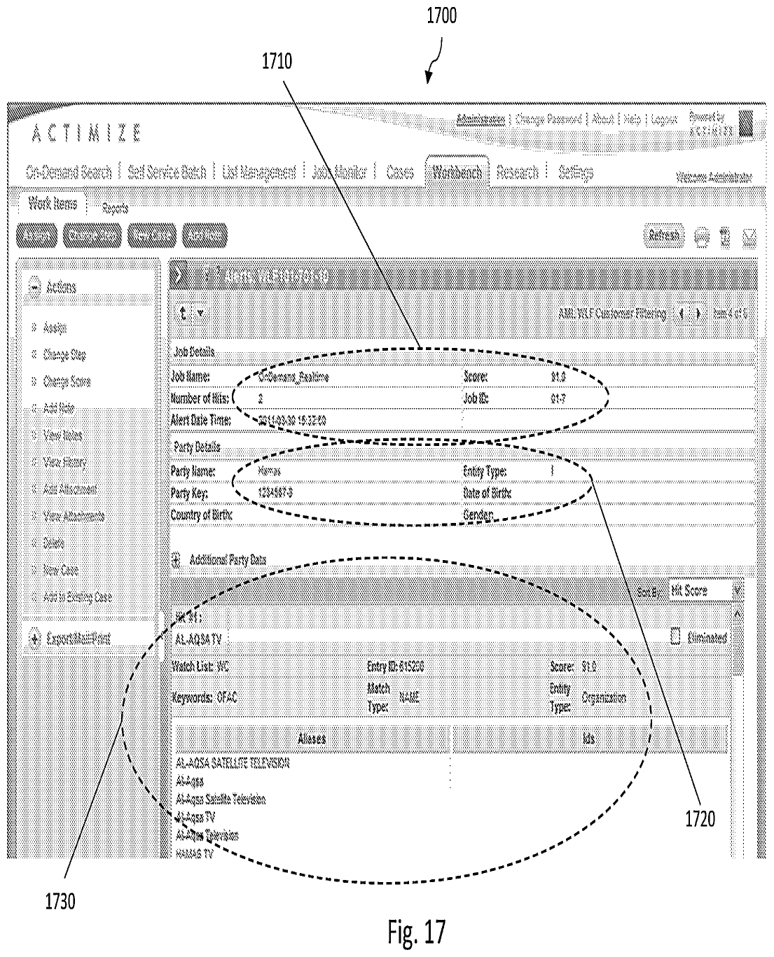

FIG. 17 is an example user interface screen 1700 for an active machine learning labeling system 200, according to aspects of the present disclosure. In the example shown in FIG. 17, the user interface screen 1700 shows detailed information for a particular data record, including job details 1710 (e.g., the time and nature of the watch list alert), party details 1720 (e.g., name, type, and identifying information of the person or entity attempting the transaction), and watch list details 1730 (e.g., data on the watch-listed entity believed to be the party attempting the transaction).

This data structure, or a similar data structure, may be used to organize and display party and watch list data that is used to generate or validate the final ML model, or “live” data that may be screened using the final ML model. The general process may for example be to screen the party's name against the sanction list or watch list maintained internally by an institution (e.g., a bank) or externally by a third-party institution. For example, a party name may be screened against the entire watch list by a toon such as the IBM GNR (global name recognition) API. GNR will return “hits” and a corresponding hit score for each hit, to which additional factors may be applied to compute a final hit score. Those records having the highest hit scores may then generate “alert” records that are passed along to the active machine learning labeling system 200.

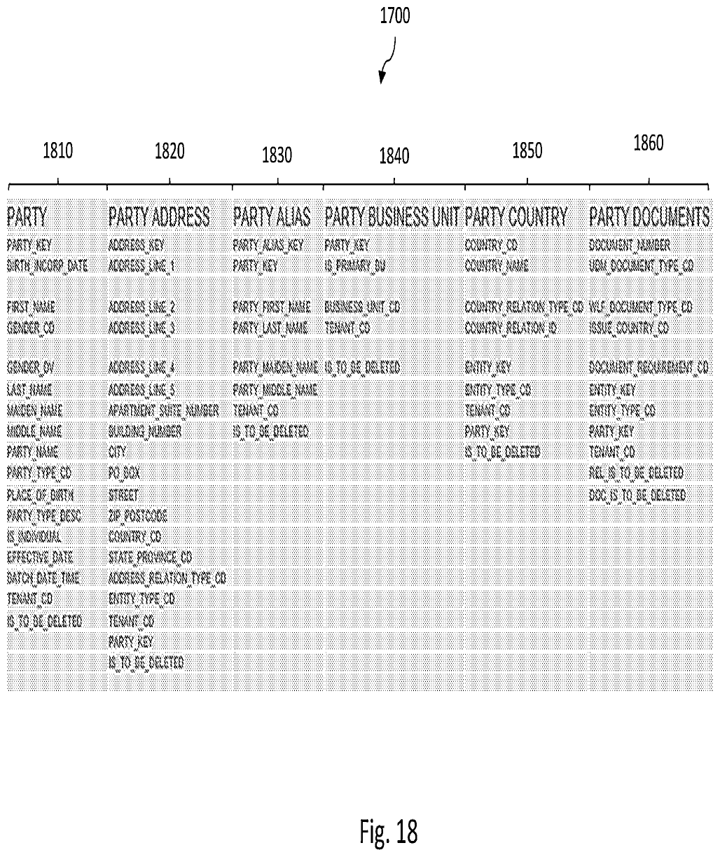

FIG. 18 is an example user interface screen 1800 for an active machine learning labeling system 200, according to aspects of the present disclosure. In the example shown in FIG. 1, the user interface screen 1800 shows watch list data for a particular watch-listed entity, including party name data 1810, physical address data 1820, known aliases 1840, information on country of residence and/or or country of origin 1850, and identifying documents 1860. Other types of data may be included in a watch list record instead of or in addition to those shown herein.

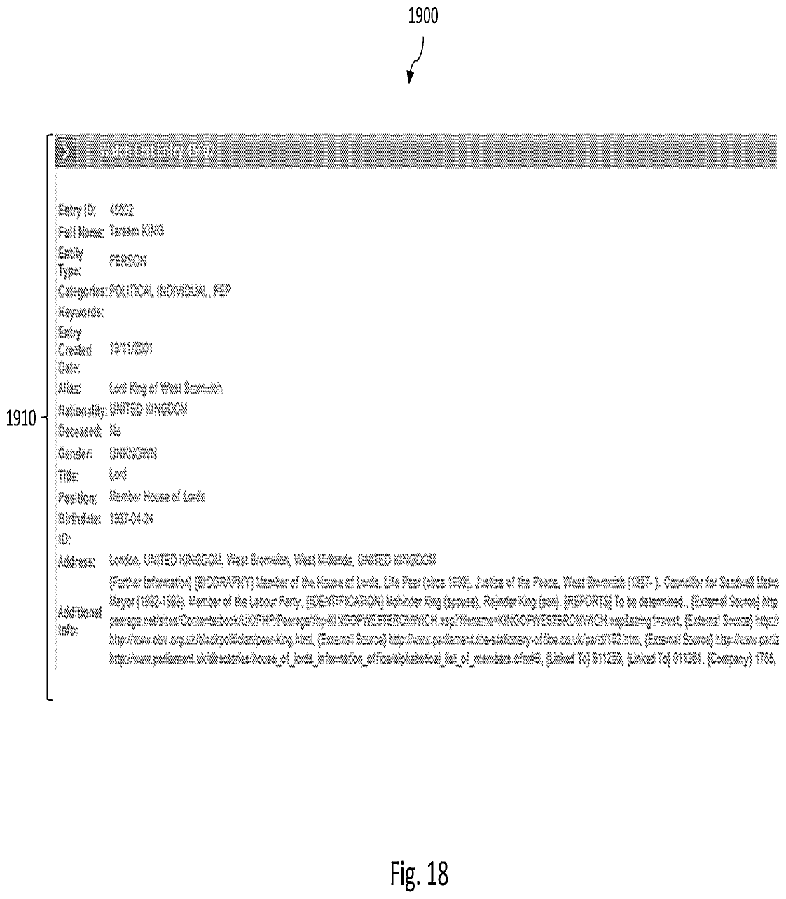

FIG. 19 is an example user interface screen 1900 for an active machine learning labeling system 200, according to aspects of the present disclosure. In the example shown in FIG. 19, the user interface screen shows a different way of representing a watch list record 1910. This record may for example be passed, as part of a larger data structure, to a GNR tool for name screening, from which a tuning log may be generated that includes features for each record. These features may then serve as inputs to the active machine learning labeling system 200, as described above.

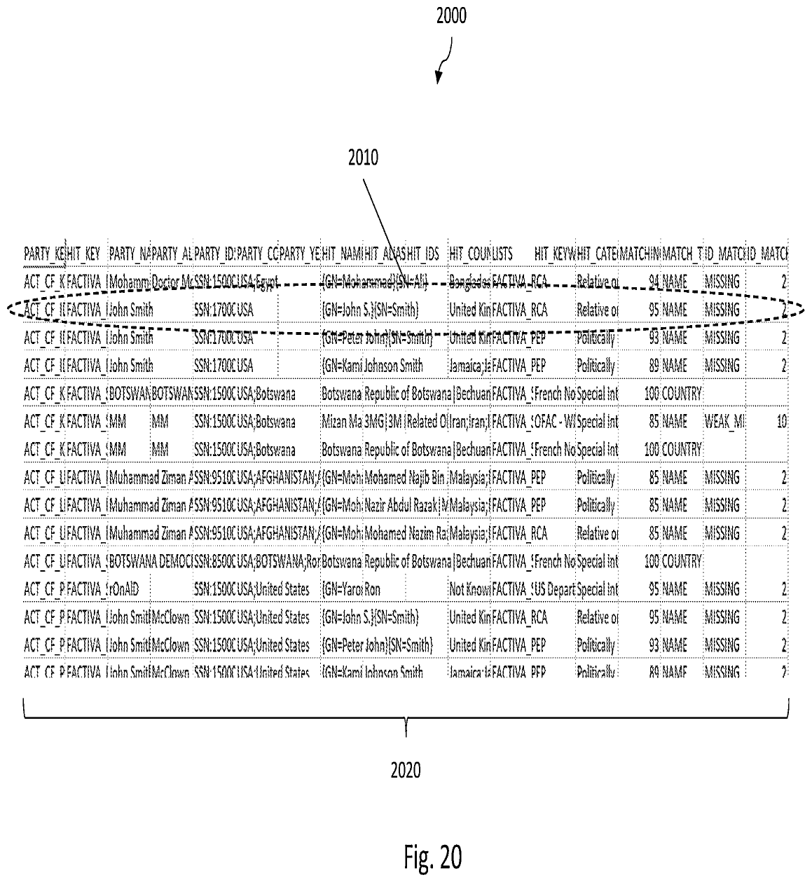

FIG. 20 is an example user interface screen 2000 for an active machine learning labeling system 200, according to aspects of the present disclosure. In the example shown in FIG. 20, the user interface screen 2000 shows a plurality of “hits” 2010, e.g., data records of transactions flagged by GNR as possibly being generated by a watch-listed entity. These hits or data records contain variables or features 2020, which serve as the inputs to the active machine learning labeling system 200, as described above.

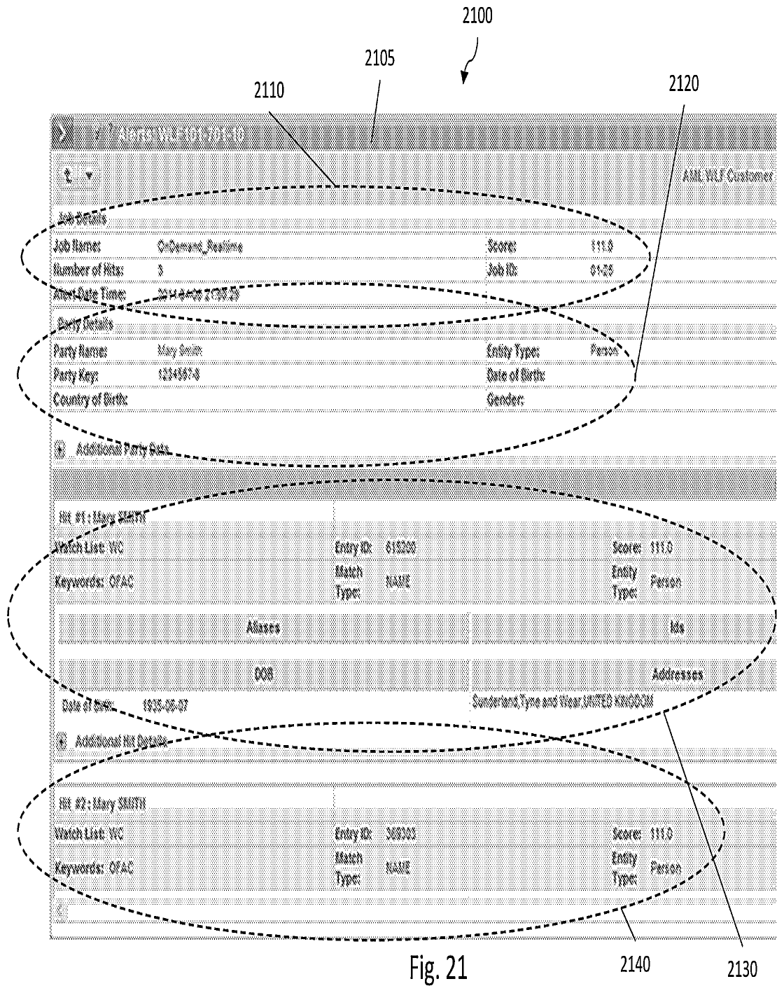

FIG. 21 is an example user interface screen 2100 for an active machine learning labeling system 200, according to aspects of the present disclosure. In the example shown in FIG. 21, the user interface screen 2100 shows an alert 2105 (e.g., a data record confirmed by the active machine learning labeling system 200 as originating from a watch-listed entity). The alert 2105 includes job details 2110 that may for example include the job name, job ID number, a number of hits, a probability score or threat score, and a time or date of the alert. The alert 2105 also contains party or entity details 2120 that identify the originator of the transaction, and may for example include a name, entity type (person, corporation, government, non-governmental entity, etc.), a party ID number or key, and a date, gender, and country of birth. The alert 2105 also contains additional party or entity details 2130 and 2140 that may for example include names, aliases, associations, addresses, threat scores, notes, and other information related to the party or entity for each “hit” generated by the GNR system.

FIG. 22 is a schematic diagram of a processor circuit 2250, according to aspects of the present disclosure. The processor circuit 2250 may be implemented in the active machine learning labeling system 200, or other devices or workstations (e.g., third-party workstations, network routers, etc.), or on a cloud processor or other remote processing unit, as necessary to implement the modules and methods disclosed herein. As shown, the processor circuit 2250 may include a processor 2260, a memory 2264, and a communication module 2268. These elements may be in direct or indirect communication with each other, for example via one or more buses.

The processor 2260 may include a central processing unit (CPU), a digital signal processor (DSP), an ASIC, a controller, or any combination of general-purpose computing devices, reduced instruction set computing (RISC) devices, application-specific integrated circuits (ASICs), field programmable gate arrays (FPGAs), or other related logic devices, including mechanical and quantum computers. The processor 2260 may also include another hardware device, a firmware device, or any combination thereof configured to perform the operations described herein. The processor 2260 may also be implemented as a combination of computing devices, e.g., a combination of a DSP and a microprocessor, a plurality of microprocessors, one or more microprocessors in conjunction with a DSP core, or any other such configuration.

The memory 2264 may include a cache memory (e.g., a cache memory of the processor 2260), random access memory (RAM), magnetoresistive RAM (MRAM), read-only memory (ROM), programmable read-only memory (PROM), erasable programmable read only memory (EPROM), electrically erasable programmable read only memory (EEPROM), flash memory, solid state memory device, hard disk drives, other forms of volatile and non-volatile memory, or a combination of different types of memory. In an embodiment, the memory 2264 includes a non-transitory computer-readable medium. The memory 2264 may store instructions 2266. The instructions 2266 may include instructions that, when executed by the processor 2260, cause the processor 2260 to perform the operations described herein. Instructions 2266 may also be referred to as code. The terms “instructions” and “code” should be interpreted broadly to include any type of computer-readable statement(s). For example, the terms “instructions” and “code” may refer to one or more programs, routines, sub-routines, functions, procedures, etc. “Instructions” and “code” may include a single computer-readable statement or many computer-readable statements.

The communication module 2268 can include any electronic circuitry and/or logic circuitry to facilitate direct or indirect communication of data between the processor circuit 2250, and other processors or devices. In that regard, the communication module 2268 can be an input/output (I/O) device. In some instances, the communication module 2268 facilitates direct or indirect communication between various elements of the processor circuit 2250 and/or the active machine learning labeling system 200. The communication module 2268 may communicate within the processor circuit 2250 through numerous methods or protocols. Serial communication protocols may include but are not limited to United States Serial Protocol Interface (US SPI), Inter-Integrated Circuit (I²C), Recommended Standard 232 (RS-232), RS-485, Controller Area Network (CAN), Ethernet, Aeronautical Radio, Incorporated 429 (ARINC 429), MODBUS, Military Standard 1553 (MIL-STD-1553), or any other suitable method or protocol. Parallel protocols include but are not limited to Industry Standard Architecture (ISA), Advanced Technology Attachment (ATA), Small Computer System Interface (SCSI), Peripheral Component Interconnect (PCI), Institute of Electrical and Electronics Engineers 488 (IEEE-488), IEEE-1284, and other suitable protocols. Where appropriate, serial and parallel communications may be bridged by a Universal Asynchronous Receiver Transmitter (UART), Universal Synchronous Receiver Transmitter (USART), or other appropriate subsystem.

External communication (including but not limited to software updates, firmware updates, or data sharing between the processor and a central server) may be accomplished using any suitable wireless or wired communication technology, such as a cable interface such as a universal serial bus (USB), micro USB, Lightning. Thunderbolt, or Fire Wire interface, Bluetooth, Wi-Fi, ZigBee, Li-Fi, or cellular data connections such as 2G/GSM (global system for mobiles), 3G/UMTS (universal mobile telecommunications system), 4G/LTE/WiMax, or 5G. For example, a Bluetooth Low Energy (BLE) radio can be used to establish connectivity with a cloud service, for transmission of data, and for receipt of software patches. The controller may be configured to communicate with a remote server, or a local device such as a laptop, tablet, or handheld device, or may include a display capable of showing status variables and other information. Information may also be transferred on physical media such as a USB flash drive or memory stick.

As will be readily appreciated by those having ordinary skill in the art after becoming familiar with the teachings herein, the active machine learning labeling system advantageously provides the capability to replace at least some human labor (e.g., review by subject matter experts) for labeling data records as either having a particular characteristic (e.g., a watch-listed entity) or not having the particular characteristic (e.g., not having a watch-listed entity). This may reduce the time, cost, and error rate associated with the labeling of data required to train a machine learning model, and enable ML models to be trained and deployed even in environments when only low-labeled data is available. The ML model learns patterns based on both human behavior and mathematics. Although specific examples for detection of financial fraud have been described herein, a person of ordinary skill in the art will appreciate that the active machine learning labeling system can be applied in any domain where ML models are trained.

Accordingly, the logical operations making up the embodiments of the technology described herein are referred to variously as operations, steps, objects, layers, elements, components, or modules. Furthermore, it should be understood that these may occur or be performed or arranged in any order, unless explicitly claimed otherwise or a specific order is inherently necessitated by the claim language.

All directional references e.g., upper, lower, inner, outer, upward, downward, left, right, lateral, front, back, top, bottom, above, below, vertical, horizontal, clockwise, counterclockwise, proximal, and distal are only used for identification purposes to aid the reader's understanding of the claimed subject matter, and do not create limitations, particularly as to the position, orientation, or use of the dimensional reduction of the disclosed system. Connection references, e.g., attached, coupled, connected, joined, or “in communication with” are to be construed broadly and may include intermediate members between a collection of elements and relative movement between elements unless otherwise indicated. As such, connection references do not necessarily imply that two elements are directly connected and in fixed relation to each other. The term “or” shall be interpreted to mean “and/or” rather than “exclusive or.” The word “comprising” does not exclude other elements or steps, and the indefinite article “a” or “an” does not exclude a plurality. Unless otherwise noted in the claims, stated values shall be interpreted as illustrative only and shall not be taken to be limiting.

The above specification, examples and data provide a complete description of the structure and use of exemplary embodiments of the active machine learning labeling system as defined in the claims. Although various embodiments of the claimed subject matter have been described above with a certain degree of particularity, or with reference to one or more individual embodiments, those skilled in the art could make numerous alterations to the disclosed embodiments without departing from the spirit or scope of the claimed subject matter.

Still other embodiments are contemplated. It is intended that all matter contained in the above description and shown in the accompanying drawings shall be interpreted as illustrative only of particular embodiments and not limiting. Changes in detail or structure may be made without departing from the basic elements of the subject matter as defined in the following claims.

What is claimed is:

1. A system adapted to automatically label data records, the system comprising:
a processor and a non-transitory computer readable medium operably coupled thereto, the computer readable medium comprising a plurality of instructions stored in association therewith that are accessible to, and executable by, the processor, to perform operations which comprise:
receiving a set of data records,
wherein each data record of the set of data records comprises a set of features that have been matched against a list of data records having a particular characteristic,
wherein some data records of the set of data records are labeled as having the particular characteristic,
wherein some data records of the set of data records are labeled as not having the particular characteristic,
wherein a majority of the data records of the set of data records are not labeled;
with the data records labeled as having the particular characteristic and the data records labeled as not having the particular characteristic, training a machine learning model;
with the trained machine learning model, of the set of data records that are not labeled, classifying each data record as either having the particular characteristic or not having the particular characteristic;
for at least some data records of the data records that are not labeled:
selecting a data record of the at least some data records that matches a decision criterion;
with a label propagation algorithm, labeling the selected data record as either having the particular characteristic or not having the particular characteristic; and
updating the trained machine learning model to include the selected data record and the labeling of the selected data record.

2. The system of claim 1, wherein the at least some data records comprise all of the data records that are not labeled.

3. The system of claim 1, wherein the at least some data records comprise, of the data records that are not labeled, a subset of data records selected by the label propagation algorithm.

4. The system of claim 1, wherein the label propagation algorithm employs least confidence sampling, margin sampling, or entropy-based sampling, or a combination thereof.

5. The system of claim 1, wherein the data records of the set of data records are mapped into a multidimensional space wherein each axis of the space represents a feature of the set of features.

6. The system of claim 5, wherein a decision boundary in the multidimensional space divides data records of the set of data records having the particular characteristic from data records of the set of data records not having the particular characteristic.

7. The system of claim 6, wherein the decision criterion comprises determining on which side of the decision boundary the selected data record falls.

8. The system of claim 1, which further comprises, for the selected data record, identifying, in a multidimensional space wherein each axis of the space represents a feature of the set of features, labeled neighbors from the data records labeled as having the particular characteristic and the data records labeled as not having the particular characteristic.

9. The system of claim 8, wherein the decision criterion comprises determining whether a majority of the labeled neighbors within a given search radius are labeled as having the particular characteristic.

10. The system of claim 8, wherein the decision criterion comprises determining whether a weighted majority of the labeled neighbors are labeled as having the particular characteristic, wherein the weighting is based on a distance between the selected record and each respective labeled neighbor within the multidimensional space.

11. The system of claim 1, wherein the particular characteristic comprises a suspicion that the data record is fraudulent, and the list of data records having the particular characteristic comprises a list of known fraud sources.

12. A computer-implemented method adapted to automatically label data records, the method comprising:
receiving a set of data records,
wherein each data record of the set of data records comprises a set of features that have been matched against a list of data records having a particular characteristic,
wherein some data records of the set of data records are labeled as having the particular characteristic,
wherein some data records of the set of data records are labeled as not having the particular characteristic,
wherein a majority of the data records of the set of data records are not labeled;
with the data records labeled as having the particular characteristic and the data records labeled as not having the particular characteristic, training a machine learning model;
with the trained machine learning model, of the set of data records that are not labeled, classifying each data record as either having the particular characteristic or not having the particular characteristic;
for at least some data records of the data records that are not labeled:
selecting a data record of the at least some data records that matches a decision criterion;
with a label propagation algorithm, labeling the selected data record as either having the particular characteristic or not having the particular characteristic; and
updating the trained machine learning model to include the selected data
record and the labeling of the selected data record.

13. The method of claim 12, wherein the at least some data records comprise all of the data records that are not labeled.

14. The method of claim 12, wherein the at least some data records comprise, of the data records that are not labeled, a subset of data records selected by the label propagation algorithm.

15. The method of claim 12, wherein the label propagation algorithm employs least confidence sampling, margin sampling, or entropy-based sampling, or a combination thereof.

16. The method of claim 12, wherein the data records of the set of data records are mapped into a multidimensional space wherein each axis of the space represents a feature of the set of features,
wherein a decision boundary in the multidimensional space divides data records of the set of data records having the particular characteristic from data records of the set of data records not having the particular characteristic, and
wherein the decision criterion comprises determining on which side of the decision boundary the selected data record falls.

17. The method of claim 12, which further comprises, for the selected data record, identifying, in a multidimensional space wherein each axis of the space represents a feature of the set of features, labeled neighbors from the data records labeled as having the particular characteristic and the data records labeled as not having the particular characteristic.

18. The method of claim 17, wherein the decision criterion comprises determining whether a majority of the labeled neighbors within a given search radius are labeled as having the particular characteristic.

19. The method of claim 17, wherein the decision criterion comprises determining whether a weighted majority of the labeled neighbors are labeled as having the particular characteristic, wherein the weighting is based on a distance between the selected record and each respective labeled neighbor within the multidimensional space.

20. The method of claim 17, wherein the particular characteristic comprises a suspicion that the data record is fraudulent, and the list of data records having the particular characteristic comprises a list of known fraud sources.
